(19) United States
(12) Patent Application Publication
(10) Pub. No.: US 2008/0320383 A1
(43) Pub. Date: Dec. 25, 2008

(54) Presentation of numerous and arbitrarily sized figures within a document

(75) Inventors: Chris Han, Seattle, WA (US); Kevin Gjerstad, Kirkland, WA (US); Michael Cooper, Vashon, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/821,629

(22) Filed: Jun. 25, 2007

(51) Int. Cl. G06F 3/14; G06F 15/00

(52) U.S. Cl. 715/252

(57) ABSTRACT

Various technologies and techniques are disclosed for displaying content with figures. All figures on a page of content are scaled so that each of the figures fits within a single column. The figures are placed as close as possible to corresponding figure references in text on the page. The page of content is displayed in a format that varies depending upon an output device. Scaled figures can be rendered in an enlarged view. Upon receiving input to select a particular one of the figures, an event handler is invoked that corresponds to the selected figure. The selected figure is displayed in an enlarged version in an enlarged viewing mode.

### BACKGROUND

Long before computers were mainstream, books, magazines, and newspapers have been created and distributed in printed form. Text and figures contained in such printed materials are typically laid out in a format that is readable and pleasing on the eye. Large figures are typically given the space they need across columns, or by taking up a half or full page. The publisher is able to lay out the particular publication in a pleasing fashion largely because the size of the publication is fixed. In the world of computers, however, the size of the output is no longer known. One computer user may have a totally different monitor or printer size than another user. What this means is that the publishers or creators of publications are not able to carefully layout content based on the size of the display medium. When there are a large number of large or arbitrarily sized figures, this problem is compounded.

### SUMMARY

Various technologies and techniques are disclosed for displaying content with figures. All figures on a page of content are scaled so that each of the figures fits within a single column. The figures are placed as close as possible to corresponding figure references in text on the page. An event handler is added to each figure that can invoke an enlarged viewing mode. The page of content is then displayed in a format that varies depending upon an output device. Upon receiving input to select a particular one of the figures, an event handler is invoked that corresponds to the selected figure. The selected figure is displayed in an enlarged version in the enlarged viewing mode.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a document viewing application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in adjusting figures based on output destination.

FIG. 5 is a process flow diagram for one implementation of the system of FIG. 1 illustrating the stages involved in printing figures in a different format than displayed on a screen.

FIG. 6 is a diagram that illustrates an example of how figures might be laid out on a page without using the techniques described herein.

FIG. 7 is a diagram for one implementation of the system of FIG. 1 that illustrates adjusting all figures in the example of FIG. 6 to each fit in a single column.

FIG. 8 is a diagram that illustrates an example of a page of content in a printed book or an electronic format that is not using the techniques described herein.

FIG. 9 is a simulated screen for one implementation of the system of FIG. 1 that illustrates how the page of content shown in FIG. 8 can be laid out on a computer screen of a certain size.

FIG. 10 is a simulated screen for one implementation of the system of FIG. 1 that illustrates how the page of content shown in FIG. 8 can be laid out on a computer screen of a different size than FIG. 9.

FIG. 11 is a simulated screen for one implementation of the system of FIG. 1 that illustrates a zooming feature that allows a user to enlarge a particular figure.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as a document viewing application, but the system also serves other purposes in addition to these. In one implementation, one or more of the techniques described herein are implemented as features with applications that provide the user of viewing contents of a document, along with other features the application may also provide.

In one implementation, a document viewing system is provided that adjusts each figure on a page down to a single column. The figure text is positioned as close to the figure as possible. By reducing the figure down to a single column, various types of output or display sizes can be supported. In other words, the content is better able to adapt for display based upon the size of the output device being used for the display. A feature is provided to allow a user to select a particular figure to view it in one or more larger sizes, such as the original size of the figure, or some other size selected programmatically or by the user.

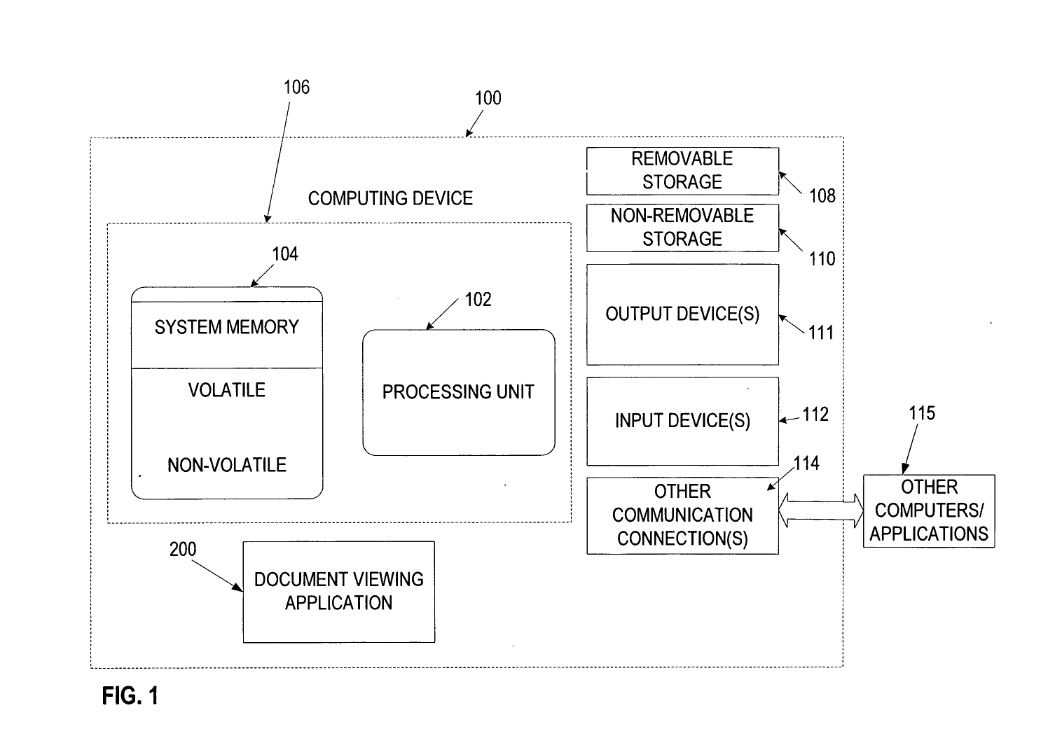

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

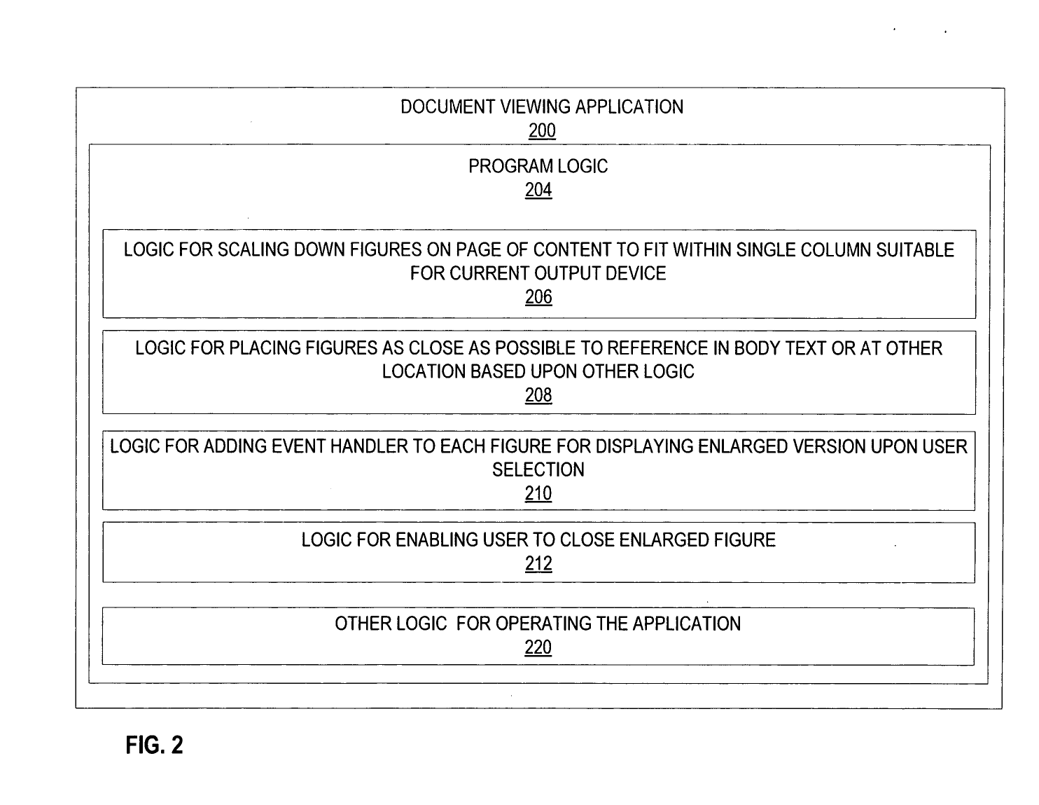

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes document viewing application 200. Document viewing application 200 will be described in further detail in FIG. 2.

Turning now to FIG. 2 with continued reference to FIG. 1, a document viewing application 200 operating on computing device 100 is illustrated. Document viewing application 200 is one of the application programs that reside on computing device 100. However, it will be understood that document viewing application 200 can alternatively or additionally be embodied as computer-executable instructions on one or more computers and/or in different variations than shown on FIG. 1. Alternatively or additionally, one or more parts of document viewing application 200 can be part of system memory 104, on other computers and/or applications 115, or other such variations as would occur to one in the computer software art.

Document viewing application 200 includes program logic 204, which is responsible for carrying out some or all of the techniques described herein. Program logic 204 includes logic for scaling down figures on page of content to fit within single column suitable for the current output device 206; logic for placing figures as close as possible to the figure reference in body text or at other location based upon other logic 208; logic for adding an event handler to each figure for displaying an enlarged version upon user selection 210; logic for enabling a user to close the enlarged FIG. 212; and other logic for operating the application 220. In one implementation, program logic 204 is operable to be called programmatically from another program, such as using a single call to a procedure in program logic 204.

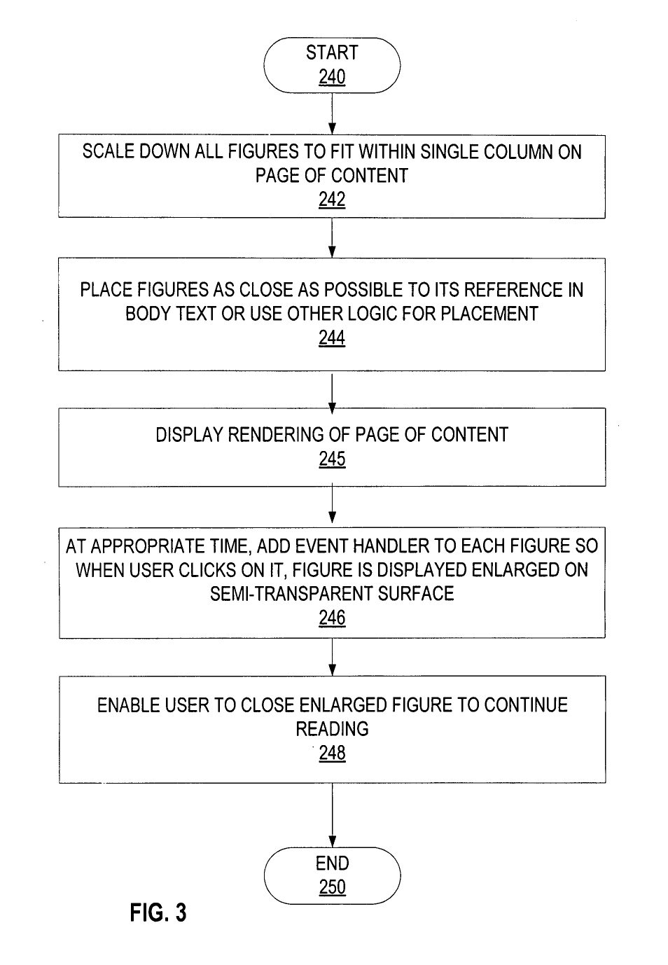

Turning now to FIGS. 3-5 with continued reference to FIGS. 1-2, the stages for implementing one or more implementations of document viewing application 200 are described in further detail. FIG. 3 is a high level process flow diagram for document viewing application 200. In one form, the process of FIG. 3 is at least partially implemented in the operating logic of computing device 100. The process begins at start point 240 with scaling down all figures to fit within a single column on a page (stage 242). A rendering of the page is generated that is better able to adapt the content for display based upon a size of the output device being used for display. The system programmatically places figures as close as possible to its figure reference in the body of the text or uses other logic for placement (stage 244). Examples of other logic that could be used for placement can include publisher settings in a settings or other file that describe some suggestions for layout placement of the figures for different output sizes. The rendering of the page of content is displayed (stage 245). In one implementation, before, during, or after the rendering of the page of content, the system also adds event handlers to each figure so when the user clicks on the figure, the figure is displayed enlarged on a semi-transparent surface (stage 246). The system enables the user to close the enlarged figure to continue reading (stage 248). The process ends at end point 250.

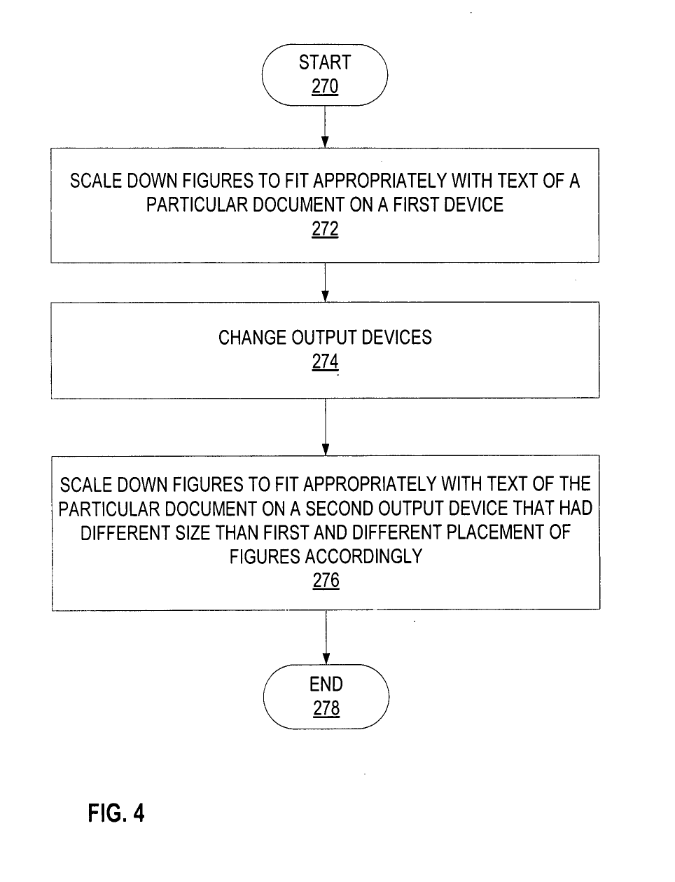

FIG. 4 illustrates one implementation of the stages involved in adjusting figures based on output destination. In one form, the process of FIG. 4 is at least partially implemented in the operating logic of computing device 100. The process begins at start point 270 with scaling down figures to fit appropriately with the text of a particular document on a first device (stage 272). The user changes output devices (stage 274). The system scales down the figures to fit appropriately with the text of the particular document on a second output device that had a different size than the first device and provides a different placement of the figures accordingly (stage 276). The process ends at end point 278.

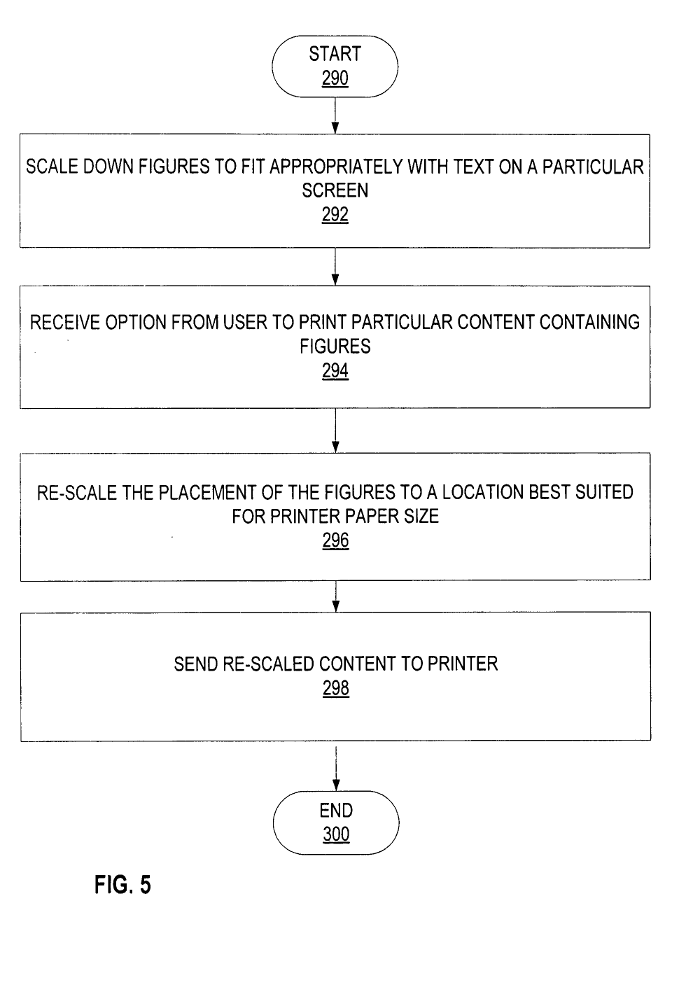

FIG. 5 illustrates one implementation of the stages involved in printing figures in a different format than displayed on a screen. In one form, the process of FIG. 5 is at least partially implemented in the operating logic of computing device 100. The process begins at start point 290 with scaling down figures to fit appropriately with the text on a particular screen (stage 292). The system receives an option from a user to print particular content containing figures (stage 294). The system re-scales the placement of the figures to a location best suited for the printer paper size (stage 296). The system sends the re-scaled content to the printer (stage 298). The process ends at end point 300.

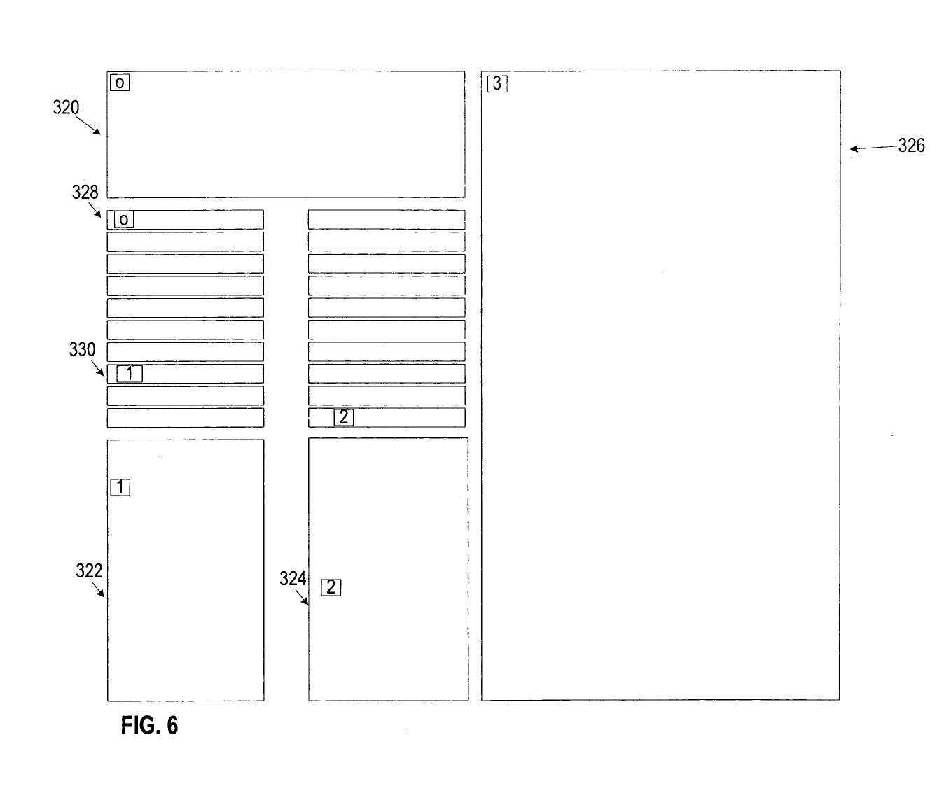

Turning now to FIG. 6-11, diagrams and simulated screens are used to illustrate the techniques discussed in FIGS. 2-5 in further detail. FIG. 6 is a diagram that illustrates an example of how figures might be laid out on a page without using the techniques described herein. As shown in the diagram, there are various figures (320, 322, 324, and 326). These figures are of varying sizes and positions. One of the figures 320 spans two columns, and another of the figures 326 takes up a half of the page. In the example shown, textual references to some of the figures are contained in the text, such as 328 and 330.

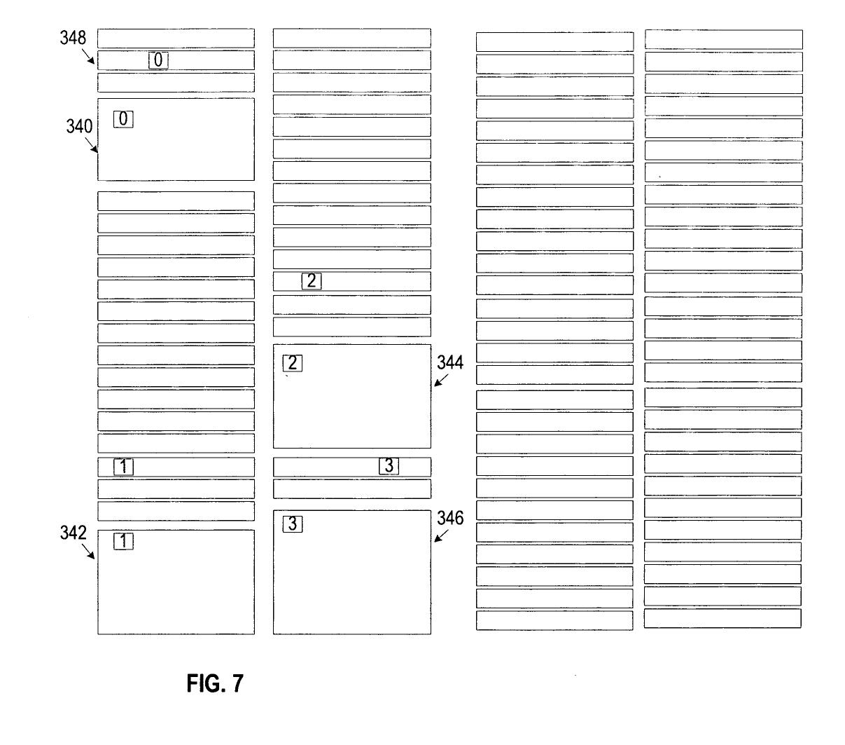

Turning now to FIG. 7, a diagram is shown that illustrates how the page of content could be laid out of a particular output device using some or all of the techniques described herein. As shown in the diagram, each of the figures (340, 342, 344, and 346) are now each contained within a single column of the text, even those that previously spanned multiple columns or the half page. The figures have been positioned as close as possible to the respective textual references to the figures in the text, such as shown in the example marked 340. More content than was previously able to fit on the page is now displayed, including the textual reference to the third figure.

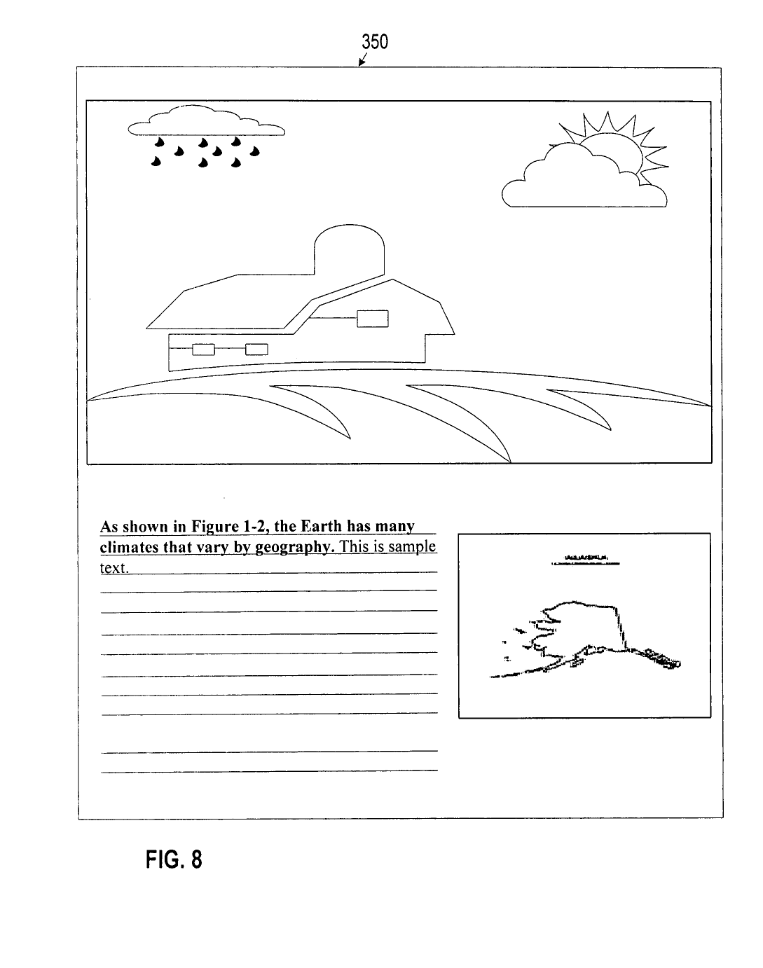

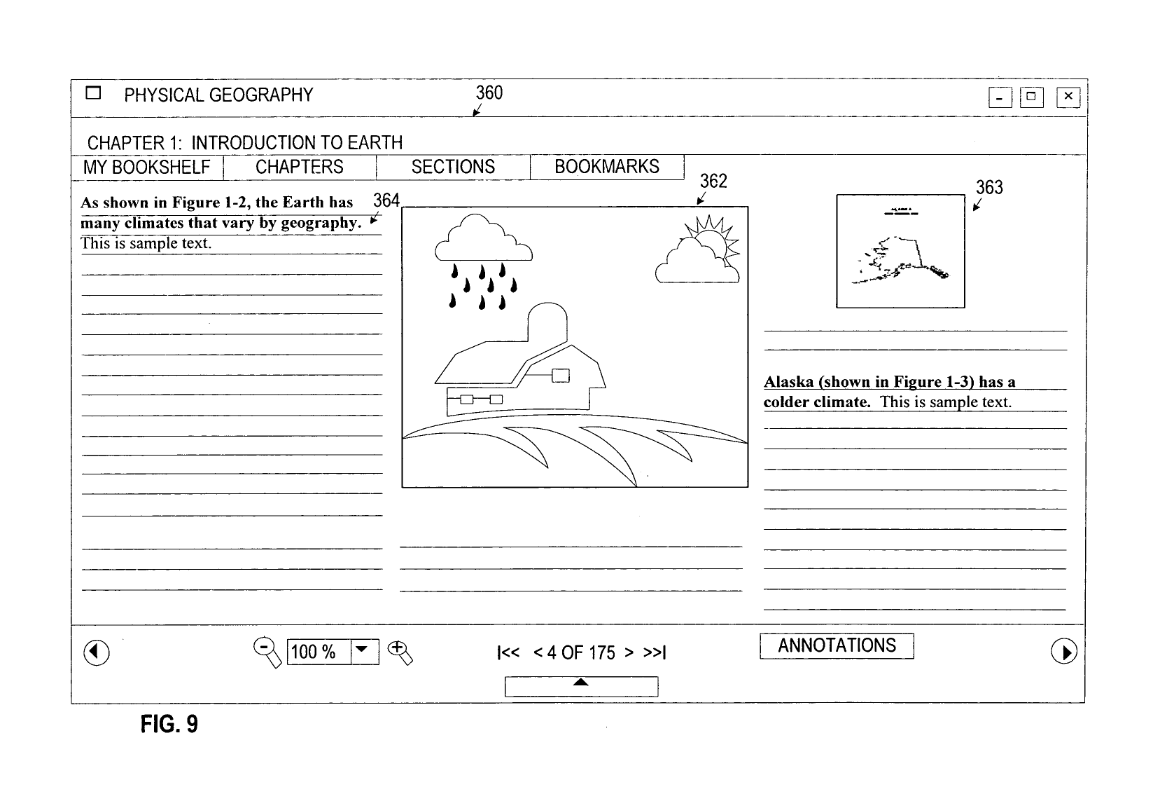

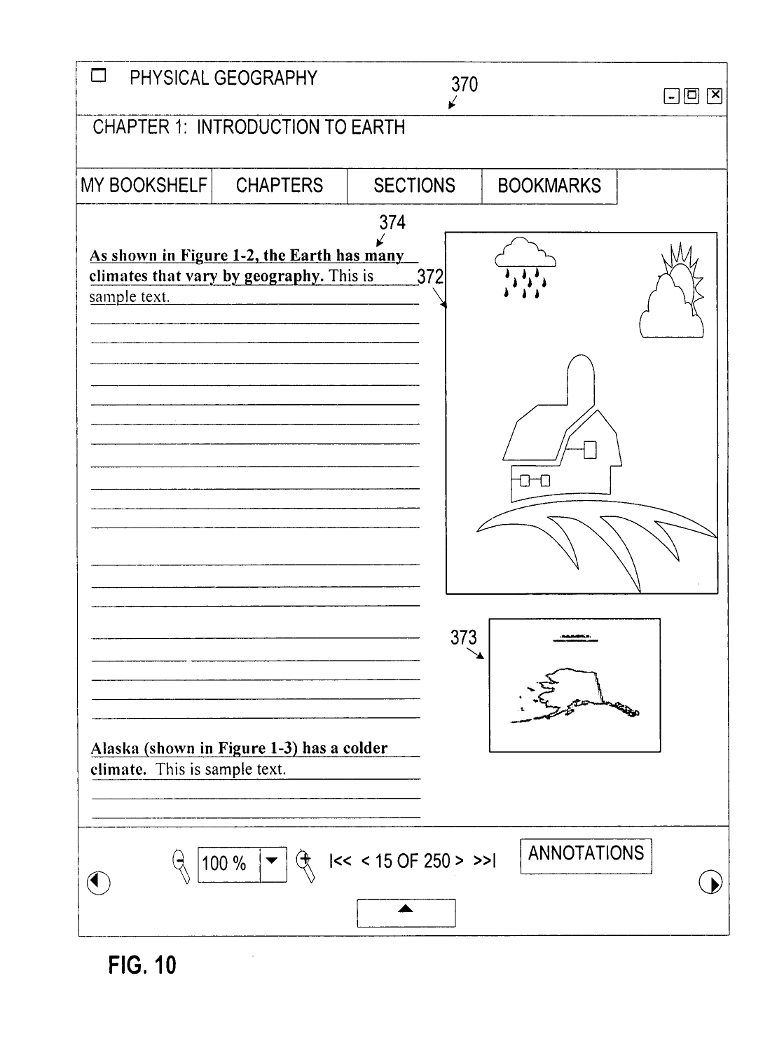

FIG. 8 is a diagram 350 that illustrates an example of a page of content in a printed book or an electronic format that is not using the techniques described herein. In the example shown, the figure spans the upper portion of the page across two columns of text. The examples of FIGS. 9 and 10 show how a digital version of that book could be adapted to a few different computer displays or other output devices. The simulated screen 360 shown in FIG. 9, for example, illustrates how the content shown in FIG. 8 is adapted to display on the particular output device. In this example, the figures (362 and 363) have been adjusted to each span just a single column, which happen to be the same column in this example. The figures could be scaled to different columns as appropriate, as long as they each just span no more than a single column. FIG. 362 has been placed in the column closest to the reference to the figure in the text 364. FIG. 10 is a simulated screen 370 showing what the content might look like on an output device of a different size than the one in FIG. 9. In this example, notice how the same content has been adjusted to a different orientation that is more vertical in nature. The page of the content shown in FIG. 8 that is not using the techniques discussed herein is also vertical in nature, but notice now how upon applying the scaling and/or other techniques discussed herein, the FIGS. 372 and 373) each span a single column, and much more text can now be displayed. There are now just two columns of text, with the reference to the figure in the text 374 again appearing close to the corresponding FIG. 372.

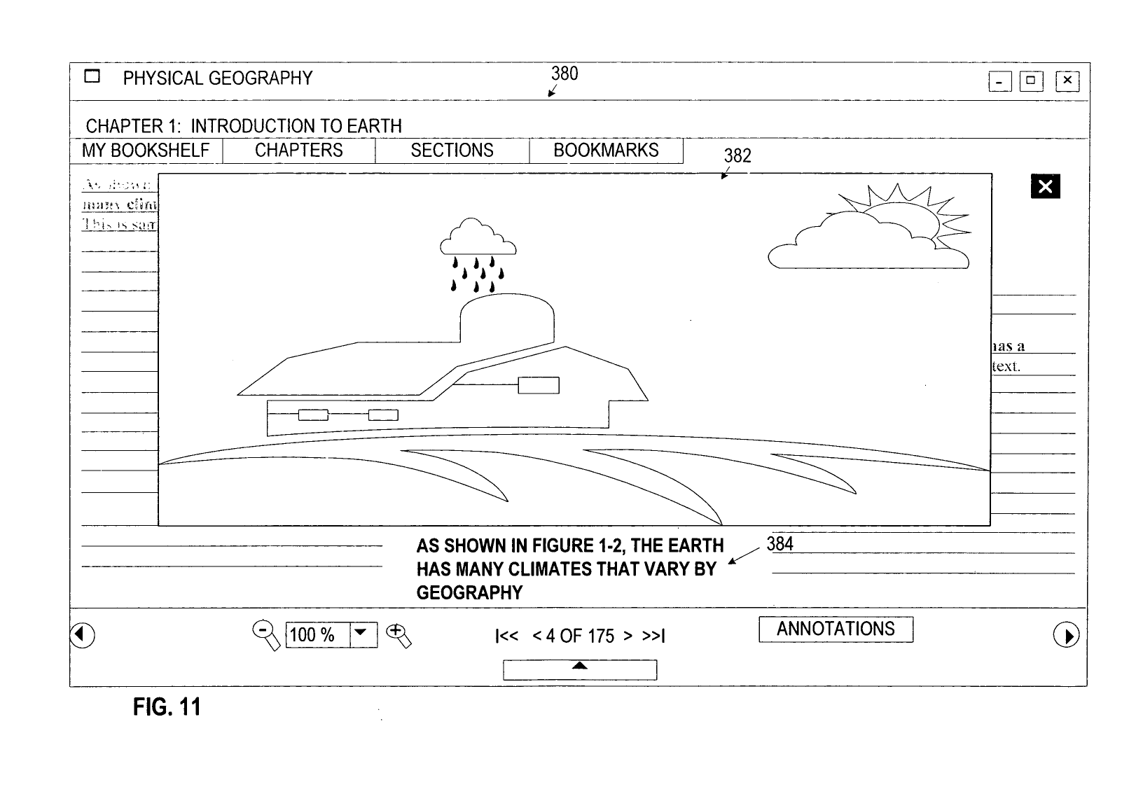

FIG. 11 is a simulated screen 380 for one implementation of the system of FIG. 1 that illustrates a zooming feature that allows a user to enlarge a particular figure. Upon selecting a particular figure, the event handler that was added to the figure is invoked to then display the figure in a larger view. In the example shown, the figure itself 382 is displayed in a larger size than on either of the screens shown in FIGS. 9 and 10. This larger size allows the user to get a better view of the contents of the figure. The reference to the figure from the text 384 has also been gathered from the text and displayed in this view along with the FIG. 382. In other implementations, the reference to the figure from the text 384 is not shown. In some cases, the user may be provided with the ability to adjust the size of the figure using the zoom in and zoom out tools. In one implementation, the display of the figure in the enlarged size is overlaid on top of the original content on the screen, with the original content being displayed semi-transparently. This can give the user the context of where they are at within the document. Other implementations do not show the original content underneath. The user can then close the enlarged view and continue reading the document.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for displaying content on a page that includes figures comprising the steps of:
providing a scaling feature that is operable to scale down each figure contained on a page of content to generate a rendering of the page that is better able to adapt for display based upon a size of an output device being used for display, where each respective figure is scaled so the respective figure is placed within a single column within the page of content; and
displaying the rendering of the page on the output device.

2. The method of claim 1, wherein each respective figure is placed at a location close to a respective textual reference of the respective figure that is contained within text of the page.

3. The method of claim 1, wherein an event handler is added to each respective figure for allowing an enlarged version of the respective figure to be displayed upon selection.

4. The method of claim 1, wherein a particular column that each figure is placed in is determined programmatically.

5. The method of claim 1, wherein a particular column that each figure is placed in is determined at least in part by a settings file.

6. The method of claim 1, wherein an event handler is added to each figure at it is placed in the page of content during the scaling stage.

7. The method of claim 6, wherein the event handler is operable to show a selected one of the figures in an enlarged mode.

8. The method of claim 7, wherein the event handler invokes the enlarged mode upon receiving a user selection.

9. The method of claim 7, wherein the enlarged mode is displayed on a semi-transparent surface.

10. The method of claim 1, wherein each figure is placed as closely as possible to a corresponding figure reference in the page of content.

11. A computer-readable medium having computer-executable instructions for causing a computer to perform the steps recited in claim 1.

12. A computer-readable medium having computer-executable instructions for causing a computer to perform steps comprising:
scale down all figures on a page of content so that each of the figures fits within a single column;
place figures as close as possible to corresponding figure references in text on the page; and
display the page of content in a format that varies depending upon an output device.

13. The computer-readable medium of claim 12, further having computer-executable instructions for causing a computer to perform steps comprising:
add an event handler to each respective figure that is operable to provide an enlarged viewing mode that displays an enlarged version of the respective figure.

14. The computer-readable medium of claim 13, wherein the event handler is operable to provide the enlarged viewing mode upon selection of the respective figure.

15. The computer-readable medium of claim 14, wherein the enlarged viewing mode is operable to show the page of content in a semi-transparent fashion beneath the enlarged version of the respective figure.

16. The computer-readable medium of claim 12, wherein the enlarged viewing mode has a close feature to allow a user to close the enlarged version of the respective figure.

17. The computer-readable medium of claim 12, wherein the format varies as a size of the output device changes.

18. A method for rendering a scaled down figure in an enlarged view comprising the steps of:
scale down all figures on a page of content so that each of the figures fits within a single column;
add an event handler to each respective figure that is operable to invoke an enlarged viewing mode that displays an enlarged version of the respective figure upon selection of the respective figure;
display the page of content in a format that varies depending upon an output device;
receive input to select a particular one of the figures;
invoke the event handler that corresponds to the selected figure; and
display the selected figure in the enlarged version in the enlarged viewing mode.

19. The method of claim 18, wherein the enlarged viewing mode is displayed on a semi-transparent surface with the page of content underneath.

20. A computer-readable medium having computer-executable instructions for causing a computer to perform the steps recited in claim 18.
